(19) United States
(12) Patent Application Publication
(10) Pub. No.: US 2026/0149782 A1
(43) Pub. Date: May 28, 2026

(54) IMAGE FORMING APPARATUS, METHOD FOR CONTROLLING IMAGE FORMING APPARATUS, AND NON-TRANSITORY COMPUTER-READABLE STORAGE MEDIUM STORING PROGRAM

(71) Applicant: SEIKO EPSON CORPORATION, TOKYO (JP)

(72) Inventor: Taisei NISHIZAWA, MATSUMOTO-SHI (JP)

(21) Appl. No.: 19/395,204

(22) Filed: Nov. 20, 2025

(30) Foreign Application Priority Data
Nov. 22, 2024 (JP) 2024-203759

(51) Int. Cl. H04N 1/34; B41J 3/46; B41J 29/20; B41J 29/393; G06F 3/12; G06Q 20/36; G06Q 20/40; H04N 1/00

(52) U.S. Cl. CPC H04N 1/346; B41J 3/46; B41J 29/20; B41J 29/393; G06F 3/1222; G06F 3/1238; H04N 1/00413; H04N 1/00875; G06Q 20/36; G06Q 20/407; H04N 2201/0094

(57) ABSTRACT

A multifunction peripheral includes a first communication controller, a second communication controller that communicates with a second terminal device in which a mobile wallet is installed, a third communication controller, an authentication section, and a print execution section. The first communication controller receives an image forming request from the first terminal device, the second communication controller receives a user ID, the authentication section performs authentication based on the user ID, the second communication controller transmits a payment request to the mobile wallet when the authentication is successfully performed, the second communication controller receives a payment execution request from the mobile wallet, the third communication controller receives a settlement completion notification from the settlement server, and the print execution section performs printing based on a print job.

The present application is based on, and claims priority from JP Application Serial Number 2024-203759, filed Nov. 22, 2024, the disclosure of which is hereby incorporated by reference herein in its entirety.

### BACKGROUND

### 1. Technical Field

The present disclosure relates to an image forming apparatus, a method for controlling the image forming apparatus, and a non-transitory computer-readable storage medium storing a program.

### 2. Related Art

In general, a technique for performing image formation by charging has been used. For example, JP-A-2008-271036 discloses a printing system for performing charging printing by cash or a prepaid card.

In recent years, an application program having a wallet function has been known as a method for paying a fee. In general, there has been a demand for securely performing image formation by charging using this application program, but there has been no mechanism for responding to this demand.

### SUMMARY

According to an aspect of the present disclosure, an image forming apparatus includes a first communication controller that communicates with a first terminal device, a second communication controller that communicates with a second terminal device in which an application program having a wallet function is installed, a third communication controller that communicates with a settlement server, an authentication section that authenticates a user, and an image formation execution section that executes image formation. The first communication controller receives an image forming request including an image forming job from the first terminal device. The second communication controller receives identification information of the user from the second terminal device. The authentication section performs authentication based on the identification information received. The second communication controller transmits a payment request for the image formation based on the image forming job to the application program when the authentication is successfully performed by the authentication section. The second communication controller receives a payment execution request corresponding to the payment request from the application program. The third communication controller transmits a settlement request for the image formation based on the image forming job to the settlement server when the payment execution request is received. The third communication controller receives a settlement completion notification from the settlement server. The image formation execution section executes the image formation based on the image forming job when the settlement completion notification is received.

According to another aspect of the present disclosure, a method for controlling an image forming apparatus includes receiving an image forming request including an image forming job from a first terminal device, receiving identification information of a user from a second terminal device in which an application program having a wallet function is installed, performing authentication based on the identification information received, transmitting, when the authentication is successfully performed, a payment request for image formation based on the image forming job to the application program, receiving a payment execution request corresponding to the payment request from the application program, transmitting a settlement request for the image formation based on the image forming job to a settlement server when the payment execution request is received, receiving a settlement completion notification from the settlement server, and executing the image formation based on the image forming job when the settlement completion notification is received.

According to a further aspect of the present disclosure, a non-transitory computer-readable storage medium storing a program that causes a processor to function as a first communication controller that communicates with a first terminal device, a second communication controller that communicates with a second terminal device in which an application program having a wallet function is installed, a third communication controller that communicates with a settlement server, an authentication section that authenticates a user, and an image formation execution section that executes image formation. The first communication controller receives an image forming request including an image forming job from the first terminal device. The second communication controller receives identification information of the user from the second terminal device. The authentication section performs authentication based on the identification information received. The second communication controller transmits a payment request for the image formation based on the image forming job to the application program when the authentication is successfully performed by the authentication section. The second communication controller receives a payment execution request corresponding to the payment request from the application program. The third communication controller transmits a settlement request for the image formation based on the image forming job to the settlement server when the payment execution request is received. The third communication controller receives a settlement completion notification from the settlement server. The image formation execution section executes the image formation based on the image forming job when the settlement completion notification is received.

### BRIEF DESCRIPTION OF THE DRAWINGS

FIG. 1 is a diagram illustrating a configuration of a printing system.

FIG. 2 is a diagram illustrating configurations of a first terminal device and a second terminal device.

FIG. 3 is a diagram illustrating configurations of a settlement server and a management server.

FIG. 4 is a diagram illustrating a configuration of a multifunction peripheral.

FIG. 5 is a sequence diagram illustrating operations of individual sections of the printing system.

FIG. 6 is a sequence diagram illustrating operations of the individual sections of the printing system.

FIG. 7 is a sequence diagram illustrating operations of the individual sections of the printing system.

FIG. 8 is a sequence diagram illustrating operations of the individual sections of the printing system.

### DESCRIPTION OF EMBODIMENTS

### 1. First Embodiment

### 1-1. Configuration of Printing System

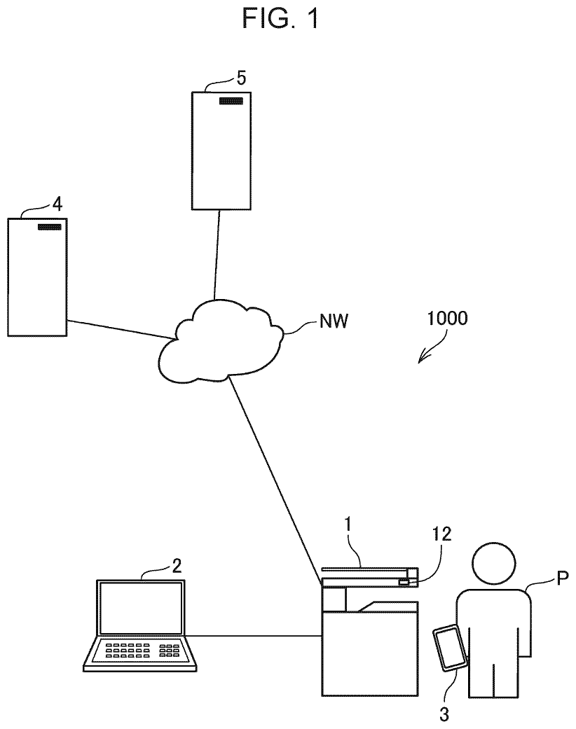

FIG. 1 is a diagram illustrating a configuration of a printing system 1000.

The printing system 1000 performs authentication printing and charging printing.

The authentication printing is performed when authentication of a user P of a multifunction peripheral 1 is successfully performed. Meanwhile, the charging printing is performed when a user is charged for printing.

The printing is an example of “image formation”. The multifunction peripheral 1 is an example of an “image forming apparatus”. A print job is an example of an “image forming job”.

The printing system 1000 includes the multifunction peripheral 1, a first terminal device 2, a second terminal device 3, a settlement server 4, and a management server 5.

The multifunction peripheral 1 is an apparatus that performs printing using a print head to generate a printed matter. The multifunction peripheral 1 has a scanning function and is an apparatus for scanning a printed matter. The multifunction peripheral 1 is connected to the first terminal device 2 used by the user P of the multifunction peripheral 1, and communicates with the first terminal device 2 in a wired or wireless manner. The multifunction peripheral 1 is further connected to a network NW, which is a wide area network (WAN), and communicates with the individual devices connected to the network NW.

Note that a printing format of the multifunction peripheral 1 may be an ink jet format or an electronic transfer format. In addition, in a case where the multifunction peripheral 1 is an ink jet type, a type of a print head included in the multifunction peripheral 1 may be a serial type, a line type, or a lateral type. Furthermore, the multifunction peripheral 1 may have other functions, such as a facsimile function, in addition to the printing function and the scanning function.

The first terminal device 2 is a personal computer (PC) used by the user P. A printer driver 211 is installed in the first terminal device 2, and a print request is transmitted to the multifunction peripheral 1 by a function of the printer driver 211. The print request is information for requesting printing, and includes a print job that the user P desires to print. Details of the print job will be described later.

The print request is an example of an “image forming request”.

Note that, although FIG. 1 illustrates a case where the first terminal device 2 is a laptop PC, the first terminal device 2 may be a desktop PC, a tablet PC, or a smartphone.

The second terminal device 3 is a PC capable of performing communication by near field communication (NFC). Furthermore, the second terminal device 3 is a PC used by the user P. The second terminal device 3 performs short-range wireless communication with the multifunction peripheral 1 by being held over an NFC reader 12 of the multifunction peripheral 1. A mobile wallet 311, which is an application program having a wallet function, is installed in the second terminal device 3.

Although FIG. 1 illustrates a case where the second terminal device 3 is a smartphone, the second terminal device 3 may be a tablet PC or a laptop PC.

The settlement server 4 is a server device that performs settlement. The settlement server 4 is connected to the network NW and communicates with the multifunction peripheral 1.

The management server 5 is a server device that manages the number of sheets printable without charging for each user P. The management server 5 is connected to the network NW and communicates with the multifunction peripheral 1.

### 1-2. Configurations of First Terminal Device and Second Terminal Device

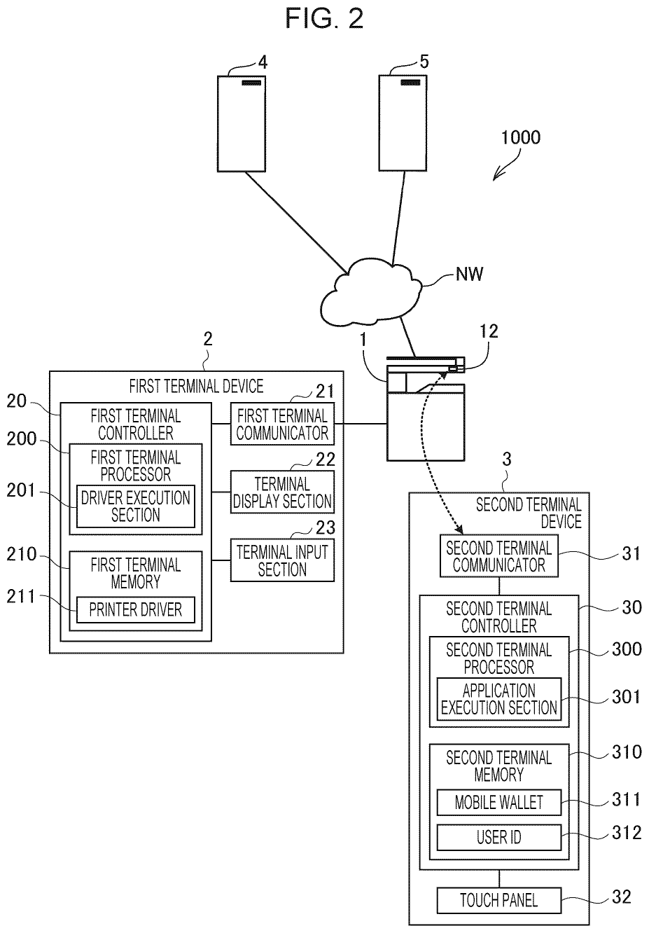

FIG. 2 is a diagram illustrating configurations of the first terminal device 2 and the second terminal device 3.

First, the configuration of the first terminal device 2 will be described.

The first terminal device 2 includes a first terminal controller 20, a first terminal communicator 21, a terminal display section 22, and a terminal input section 23.

The first terminal communicator 21 includes communication hardware, such as a communication circuit, and communicates with the multifunction peripheral 1 under the control of the first terminal controller 20.

The terminal display section 22 includes a display, and displays various types of information on the display under the control of the first terminal controller 20.

The terminal input section 23 is an interface that is connected to an input unit, such as an operation switch included in the first terminal device 2, a panel having a touch input function, a mouse, and a keyboard, detects an operation on the input unit, and outputs a detection result to the first terminal controller 20. The first terminal controller 20 executes a process corresponding to an operation on the input unit based on an input from the terminal input section 23.

The first terminal controller 20 includes a first terminal processor 200, such as a central processing unit (CPU) or a micro-processing unit (MPU), a first terminal memory 210, and an interface circuit for connecting other devices and sensors, and controls the individual sections of the first terminal device 2. The first terminal communicator 21, the terminal display section 22, and the terminal input section 23 are connected to the first terminal controller 20.

The first terminal memory 210 is a device that stores programs and data. The first terminal memory 210 stores data and the like processed by the printer driver 211 and the first terminal processor 200. The first terminal memory 210 has a nonvolatile storage area. Furthermore, the first terminal memory 210 includes a volatile storage area and configures a work area of the first terminal processor 200. The first terminal memory 210 is configured by, for example, a read only memory (ROM) or a random access memory (RAM).

The first terminal processor 200 functions as a driver execution section 201 when reading and executing the printer driver 211 stored in the first terminal memory 210.

The driver execution section 201 generates a print job. Note that the print job includes image data, print condition information indicating a print condition, such as the number of sheets to be printed, and a control command conforming to a command system of the multifunction peripheral 1. After generating the print job, the driver execution section 201 transmits a print request including the generated print job to the multifunction peripheral 1 via the first terminal communicator 21.

Next, a configuration of the second terminal device 3 will be described.

The second terminal device 3 includes a second terminal controller 30, a second terminal communicator 31, and a touch panel 32.

The second terminal communicator 31 includes communication hardware conforming to the NFC communication standard, such as a communication circuit. When the second terminal device 3 is located within a communicable distance of the NFC reader 12, the second terminal communicator 31 communicates with the multifunction peripheral 1 under the control of the second terminal controller 30.

The touch panel 32 includes a display panel and a touch sensor disposed on the display panel in an overlapping manner or integrally with the display panel.

The second terminal controller 30 includes a second terminal processor 300, such as a CPU or an MPU, a second terminal memory 310, and an interface circuit for connecting other devices and sensors, and controls the individual sections of the second terminal device 3. The second terminal communicator 31 and the touch panel 32 are connected to the second terminal controller 30.

The second terminal memory 310 is a device that stores programs and data. The second terminal memory 310 stores a mobile wallet 311, a user identification (ID) 312, data processed by the second terminal processor 300, and the like. The second terminal memory 310 has a nonvolatile storage area. The second terminal memory 310 includes a volatile storage area, and constitutes a work area of the second terminal processor 300. The second terminal memory 310 is configured by, for example, a ROM or a RAM.

The user ID 312 is identification information of the user P. The user ID 312 may be any information that can uniquely identify the user P, and may be, for example, a credit card number or an ID assigned to a user of the mobile wallet 311.

The second terminal processor 300 functions as an application execution section 301 by reading and executing the mobile wallet 311 stored in the second terminal memory 310.

The application execution section 301 communicates with the multifunction peripheral 1 via the second terminal communicator 31. Furthermore, the application execution section 301 displays various types of information on the touch panel 32. The application execution section 301 accepts various operations performed by the user P via the touch panel 32.

### 1-3. Configurations of Settlement Server and Management Server

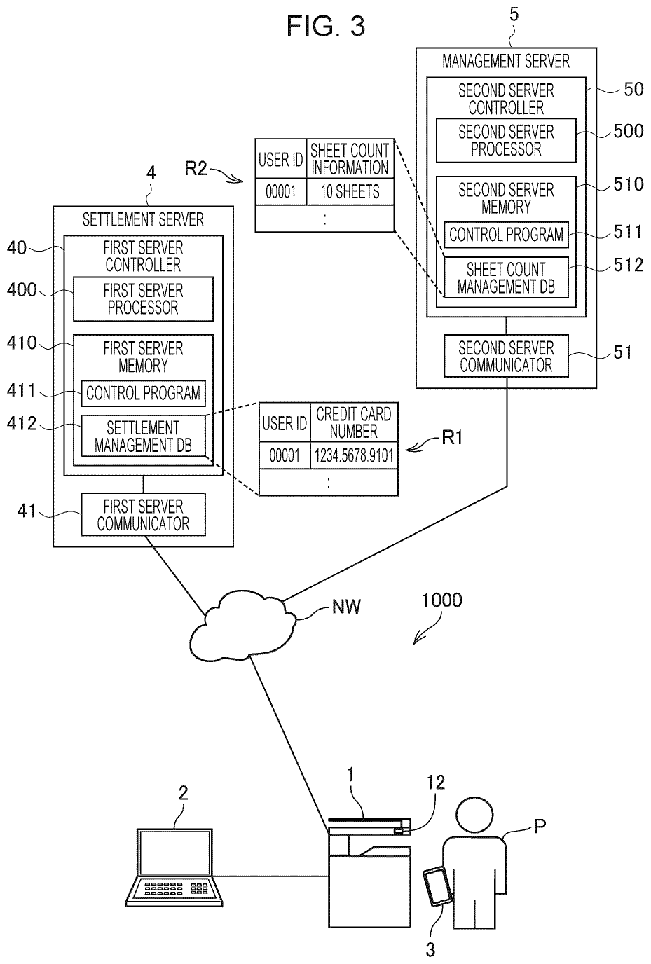

FIG. 3 is a diagram illustrating configurations of the settlement server 4 and the management server 5.

First, the configuration of the settlement server 4 will be described.

The settlement server 4 includes a first server controller 40 and a first server communicator 41.

The first server communicator 41 includes communication hardware, such as a communication circuit, and communicates with the multifunction peripheral 1 under the control of the first server controller 40.

The first server controller 40 includes a first server processor 400, such as a CPU or an MPU, a first server memory 410, and an interface circuit for connecting other devices and sensors, and controls the individual sections of the settlement server 4. The first server communicator 41 is connected to the first server controller 40.

The first server memory 410 is a device that stores programs and data. The first server memory 410 stores a control program 411, a settlement management database (DB) 412, data to be processed by the first server processor 400, and the like. The first server memory 410 has a nonvolatile storage area. In addition, the first server memory 410 includes a volatile storage area and configures a work area of the first server processor 400. The first server memory 410 is configured by, for example, a ROM or a RAM.

The settlement management DB 412 is a database that stores, for each user P, a record ID R1 in which the user ID 312 and a credit card number are associated with each other.

The first server controller 40 communicates with the multifunction peripheral 1 via the first server communicator 41 by the first server processor 400 executing the control program 411. In addition, the first server controller 40 executes a settlement process by the first server processor 400 executing the control program 411. Details of the settlement process will be described later.

Next, a configuration of the management server 5 will be described.

The management server 5 includes a second server controller 50 and a second server communicator 51.

The second server communicator 51 includes communication hardware, such as a communication circuit, and communicates with the multifunction peripheral 1 under the control of the second server controller 50.

The second server controller 50 includes a second server processor 500, such as a CPU or an MPU, a second server memory 510, and an interface circuit for connecting other devices and sensors, and controls the individual sections of the management server 5. A second server communicator 51 is connected to the second server controller 50.

The second server memory 510 is a device that stores programs and data. The second server memory 510 stores a control program 511, a sheet count management DB 512, and data to be processed by the second server processor 500. The second server memory 510 has a nonvolatile storage area. In addition, the second server memory 510 includes a volatile storage area, and configures a work area of the second server processor 500. The second server memory 510 is configured by, for example, a ROM or a RAM.

The sheet count management DB 512 is a database that stores, for each user P, a record R2 in which the user ID 312 and sheet count information are associated with each other. The sheet count information is information indicating the number of sheets printable without charging.

The second server controller 50 communicates with the multifunction peripheral 1 via the second server communicator 51 by the second server processor 500 executing the control program 511. In addition, the second server controller 50 updates the sheet count management DB 512 by the second server processor 500 executing the control program 511. This update will be described later.

### 1-4. Configuration of Multifunction Peripheral

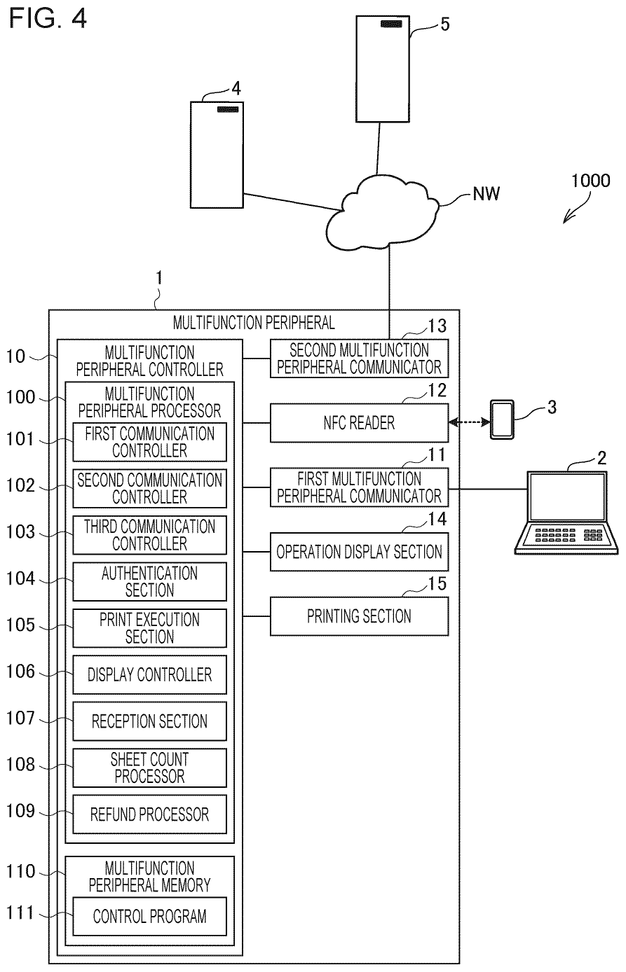

FIG. 4 is a diagram illustrating a configuration of the multifunction peripheral 1.

The multifunction peripheral 1 includes a multifunction peripheral controller 10, a first multifunction peripheral communicator 11, the NFC reader 12, a second multifunction peripheral communicator 13, an operation display section 14, and a printing section 15.

The operation display section 14 is an example of a “display section”.

The first multifunction peripheral communicator 11 includes communication hardware, such as a communication circuit, and communicates with the first terminal device 2 under the control of the multifunction peripheral controller 10. Note that a communication standard of the first multifunction peripheral communicator 11 may be a wireless communication standard or a wired communication standard.

The NFC reader 12 includes communication hardware conforming to the NFC communication standard, and communicates with the second terminal device 3 located within a communicable distance under the control of the multifunction peripheral controller 10.

The second multifunction peripheral communicator 13 includes communication hardware, such as a communication circuit, and communicates with a device connected to the network NW under the control of the multifunction peripheral controller 10. Note that a communication standard of the second multifunction peripheral communicator 13 may be a wireless communication standard or a wired communication standard.

The operation display section 14 includes operation buttons and a display panel. The operation display section 14 accepts a user's operation performed on the multifunction peripheral 1 and displays various types of information on the display panel. The display panel included in the operation display section 14 may be a touch panel that accepts a touch operation.

The printing section 15 includes a printing mechanism and performs printing on a printing medium under the control of the multifunction peripheral controller 10. A printing function includes a print head, a transport mechanism that transports a printing medium, and the like.

The multifunction peripheral controller 10 includes a multifunction peripheral processor 100, such as a CPU or an MPU, a multifunction peripheral memory 110, and an interface circuit for connecting other devices and sensors, and controls the individual sections of the multifunction peripheral 1. The first multifunction peripheral communicator 11, the NFC reader 12, the second multifunction peripheral communicator 13, the operation display section 14, and the printing section 15 are connected to the multifunction peripheral controller 10. Although not illustrated, a scanning section including a scanning mechanism, such as a scan head, is connected to the multifunction peripheral controller 10.

The multifunction peripheral processor 100 is an example of a “processor”.

The multifunction peripheral memory 110 is a device for storing programs and data. The multifunction peripheral memory 110 stores the control program 111, data to be processed by the multifunction peripheral processor 100, and the like. The multifunction peripheral memory 110 has a nonvolatile storage area. The multifunction peripheral memory 110 has a volatile storage area and constitutes a work area of the multifunction peripheral processor 100. The multifunction peripheral memory 110 is constituted by, for example, a ROM or a RAM.

The control program 111 is an example of a “program”.

By reading and executing the control program 111 stored in the multifunction peripheral memory 110, the multifunction peripheral processor 100 functions as a first communication controller 101, a second communication controller 102, a third communication controller 103, an authentication section 104, a print execution section 105, a display controller 106, a reception section 107, a sheet count processor 108, and a refund processor 109.

The print execution section 105 is an example of an “image formation execution section”.

The first communication controller 101 communicates with the first terminal device 2 via the first multifunction peripheral communicator 11.

The second communication controller 102 communicates with the second terminal device 3 via the NFC reader 12.

The third communication controller 103 communicates with the settlement server 4 and the management server 5 via the second multifunction peripheral communicator 13.

The authentication section 104 authenticates the user P. As will be described later, the authentication section 104 performs authentication based on the user ID 312 received by the second communication controller 102. In detail, the authentication section 104 transmits the user ID 312 to the management server 5 using the third communication controller 103. The management server 5 refers to the authentication database that stores the user ID 312, and determines whether the received user ID 312 is stored in the authentication database, thereby performing authentication based on the user ID 312. Subsequently, when the received user ID 312 is stored in the authentication database, the management server 5 transmits an authentication result indicating successful authentication to the multifunction peripheral 1. On the other hand, when the received user ID 312 is not stored in the authentication database, the management server 5 transmits an authentication result indicating authentication failure to the multifunction peripheral 1. The authentication section 104 determines that the authentication has been successfully performed when the authentication result received from the management server 5 is the authentication success, and determines that the authentication has failed when the authentication result received from the management server 5 is the authentication failure.

Note that the authentication database may be stored in another server device connected to the network NW. Examples of the server device include the settlement server 4 and other server devices.

The print execution section 105 causes the printing section 15 to execute printing.

The display controller 106 causes the operation display section 14 to display various types of information.

The reception section 107 accepts various operations from the user P via the operation display section 14.

When an error occurs in printing executed by the print execution section 105, the sheet count processor 108 performs a process of adding the number of sheets printable without charging to the user ID 312. Details of the process of the sheet count processor 108 will be described later.

In a case where an error occurs in the printing executed by the print execution section 105, the refund processor 109 executes a refund process on the mobile wallet 311. The refund process will be described in detail later.

### 1-5. Operations of Individual Sections of Printing System

Next, operations of the individual sections of the printing system 1000 will be described.

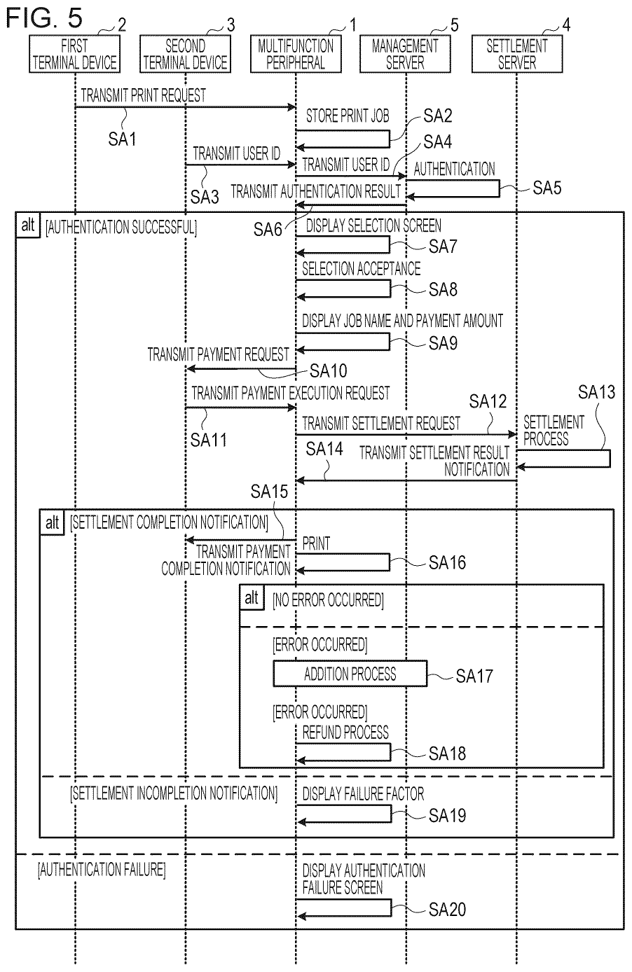

FIG. 5 is a sequence diagram illustrating operations of the individual sections of the printing system 1000.

When an instruction for a print request is received from the user P via the terminal input section 23, the driver execution section 201 transmits the print request to the multifunction peripheral 1 (step SA1).

Next, upon receiving the print request from the first terminal device 2, the first communication controller 101 stores a print job included in the received print request in the multifunction peripheral memory 110 (step SA2).

When the first terminal device 2 transmits the print request, the user P goes to the multifunction peripheral 1 and holds the second terminal device 3 over the NFC reader 12 of the multifunction peripheral 1.

When the second terminal device 3 is held over the NFC reader 12 and performs short-range wireless communication with the multifunction peripheral 1, the application execution section 301 transmits the user ID 312 stored in the second terminal memory 310 to the multifunction peripheral 1 (step SA3).

Next, when the second communication controller 102 receives the user ID 312, the authentication section 104 causes the third communication controller 103 to transmit the user ID 312 to the management server 5 (step SA4).

When the user ID 312 is received from the multifunction peripheral 1, the second server processor 500 determines whether the received user ID 312 has been stored in the authentication database so as to perform authentication based on the user ID 312 (step SA5).

Next, the second server processor 500 transmits an authentication result to the multifunction peripheral 1 (step SA6). The authentication section 104 determines whether the authentication of the user P has been successfully performed or failed based on the authentication result received by the third communication controller 103.

When the authentication section 104 determines that the authentication has been successfully performed, the display controller 106 causes the operation display section 14 to display a selection screen (step SA7). The selection screen is a screen for selecting one or a plurality of print jobs from print jobs stored in the multifunction peripheral memory 110, and displays a list of job names of the print jobs stored in the multifunction peripheral memory 110.

When the multifunction peripheral 1 displays the selection screen, the user P selects the print job included in the print request transmitted by the first terminal device 2 on the selection screen. That is, the user P selects a print job desired to be printed on the selection screen.

The reception section 107 accepts a selection of a print job (step SA8). Next, the display controller 106 causes the operation display section 14 to display a job name of the print job selected by the user P and a payment amount (step SA9). The payment amount is an amount to be paid by the user P for printing based on the print job to be printed. In this embodiment, the payment amount is an amount to be paid by the user P for printing based on the print job selected on the selection screen. Note that the display controller 106 calculates the payment amount based on print condition information included in the print job, and displays the calculated payment amount on the operation display section 14.

When the multifunction peripheral 1 displays the payment amount, the user P holds the second terminal device 3 over the NFC reader 12 of the multifunction peripheral 1 again.

When the second terminal device 3 is held over the NFC reader 12 again and performs short-range wireless communication with the multifunction peripheral 1, the second communication controller 102 transmits a payment request to the mobile wallet 311 (step SA10). That is, in step SA10, the second communication controller 102 transmits a payment request to the second terminal device 3. The payment request is information for requesting payment for printing based on the print job to be printed. Note that the payment request according to this embodiment is information for requesting payment for printing based on the print job selected on the selection screen.

Subsequently, upon receiving the payment request, the application execution section 301 transmits a payment execution request to the multifunction peripheral 1 (step SA11). That is, in step SA11, the mobile wallet 311 transmits a payment execution request to the multifunction peripheral 1. The payment execution request is information for requesting execution of payment in response to the payment request.

When the second communication controller 102 receives the payment execution request, the third communication controller 103 transmits a settlement request to the settlement server 4 (step SA12). The settlement request is information for requesting settlement for printing based on the print job to be printed. The settlement request according to this embodiment is information for requesting settlement for printing based on the print job selected on the selection screen. The settlement request includes the user ID 312 received from the second terminal device 3 and payment amount information indicating the payment amount.

When the settlement request is received, the first server controller 40 performs a settlement process based on the received settlement request (step SA13).

Step SA13 will be described in detail.

The first server controller 40 specifies a record R1 having the user ID 312 included in the settlement request in the settlement management DB 412. Thereafter, the first server controller 40 performs settlement based on a credit card number included in the specified record R1 and the payment amount indicated by the payment amount information included in the settlement request.

The first server controller 40 transmits a settlement result notification to the multifunction peripheral 1 (step SA14). The settlement result notification is information for notifying a result of the settlement process in step SA13. In step SA14, the first server controller 40 transmits the settlement result notification that is either a settlement completion notification or a settlement incompletion notification. The settlement completion notification is information for notifying that the settlement process of step SA13 has been successfully performed. On the other hand, the settlement incompletion notification is information for notifying that the settlement process of step SA13 has failed. The settlement incompletion notification includes failure factor information indicating a factor of the settlement failure.

When the third communication controller 103 receives the settlement completion notification, the second communication controller 102 transmits a payment completion notification to the second terminal device 3 (step SA15). The payment completion notification is information for notifying that the payment is completed. In step SA15, the second communication controller 102 may transmit paid amount information instead of the payment completion notification or together with the payment completion notification. The paid amount information is information indicating the amount of money paid for printing based on the print job to be printed. The amount indicated by the paid amount information is the same as the payment amount.

Subsequently, the print execution section 105 executes printing based on the print job to be printed (step SA16). In this embodiment, the print execution section 105 executes printing based on the print job selected on the selection screen.

When no error occurs in the printing performed by the print execution section 105, the multifunction peripheral 1 ends the process. Examples of the error include running out of paper, a paper jam, and a shortage of a printing material, such as ink.

On the other hand, when an error occurs in the printing performed by the print execution section 105, the printing system 1000 performs step SA17 or step SA18.

In step SA17, the multifunction peripheral 1 and the management server 5 execute an addition process.

Step SA17 will be described in detail.

The sheet count processor 108 acquires the number of sheets to be subjected to printing from the print condition information of the print job to be printed. In this embodiment, the sheet count processor 108 acquires the number of sheets to be subjected to printing from the print condition information of the print job selected on the selection screen.

Next, the sheet count processor 108 determines the acquired number of sheets to be subjected to printing as the number of sheets printable without charging. Then, the sheet count processor 108 performs a process of adding the acquired number of sheets to be subjected to printing for the user ID 312 transmitted by the second terminal device 3. To be more specific about the addition process, the sheet count processor 108 outputs the user ID 312 transmitted by the second terminal device 3 and the sheet count information indicating the acquired number of sheets to be subjected to printing to the third communication controller 103. As a result, the user ID 312 and the sheet count information are transmitted to the management server 5.

In the addition process, the second server controller 50 specifies the record R2 having the received user ID 312 in the sheet count management DB 512, and adds the number of sheets to be subjected to printing indicated by the received sheet count information to the number of sheets indicated by the sheet count information of the specified record R2.

In step SA18, the refund processor 109 executes a refund process. The refund process is a process of refunding the amount of money paid for printing based on the print job to be printed.

Step SA18 will be described in detail.

The refund processor 109 transmits the user ID 312 transmitted by the second terminal device 3 and a refund request to the settlement server 4. The refund request is information for requesting a refund, and includes refund amount information indicating a refund amount. The refund amount is the same as the payment amount. The settlement server 4 specifies the record R1 having the user ID 312 included in the refund request in the settlement management DB 412. Next, the settlement server 4 refunds based on the credit card number included in the specified record R1 and the refund amount indicated by the refund amount information included in the refund request.

Note that, in step SA18, the refund processor 109 may cause the second communication controller 102 to transmit the refund information. The refund information is information indicating that a refund is to be made, and includes refund amount information. In this configuration, the refund processor 109 causes the display controller 106 to display a message prompting the user to hold the terminal over the NFC reader 12 again. When the second terminal device 3 is held over the NFC reader 12 again and performs short-range wireless communication with the multifunction peripheral 1, the second terminal device 3 causes the second communication controller 102 to transmit the refund information. As a result, the money is refunded to the mobile wallet 311 via the multifunction peripheral 1. Note that, when the second terminal device 3 and the settlement server 4 can communicate with each other, the second terminal device 3 may receive the refund information from the settlement server 4. Accordingly, the refund is made to the mobile wallet 311 via the settlement server 4.

When the third communication controller 103 receives the settlement incompletion notification, the display controller 106 causes the operation display section 14 to display the failure factor information included in the received settlement incompletion notification (step SA19).

When the authentication section 104 determines that the authentication has failed, the display controller 106 causes the operation display section 14 to display an authentication failure screen (step SA20). The authentication failure screen indicates that the authentication has failed.

### 1-6. Configuration and Effect

As described above, the multifunction peripheral 1 includes the first communication controller 101 that communicates with the first terminal device 2. Furthermore, the multifunction peripheral 1 includes the second communication controller 102 that communicates with the second terminal device 3 in which the mobile wallet 311 is installed. The multifunction peripheral 1 further includes the third communication controller 103 that communicates with the settlement server 4. The multifunction peripheral 1 further includes the authentication section 104 that authenticates the user P. The multifunction peripheral 1 further includes the print execution section 105 that executes printing. The first communication controller 101 receives a print request including a print job from the first terminal device 2. The second communication controller 102 receives the user ID 312 from the second terminal device 3. The authentication section 104 performs authentication based on the received user ID 312. When the authentication is successfully performed by the authentication section 104, the second communication controller 102 transmits a payment request for the printing based on the print job to the mobile wallet 311. The second communication controller 102 receives a payment execution request corresponding to the payment request from the mobile wallet 311. When the payment execution request is received, the third communication controller 103 transmits a settlement request for the printing based on the print job to the settlement server 4. The third communication controller 103 receives a settlement completion notification from the settlement server 4. When the settlement completion notification is received, the print execution section 105 executes the printing based on the print job.

According to this, charging printing and authentication printing using the mobile wallet 311 can be performed. Therefore, it is possible to perform charging printing without bringing cash, a prepaid card, or the like to the multifunction peripheral 1, and it is possible to perform printing in which the risk of information leakage is suppressed. Therefore, it is possible to securely perform charging printing using the mobile wallet 311.

The multifunction peripheral 1 includes the display controller 106 that causes the operation display section 14 to display the print job when the authentication is successfully performed by the authentication section 104. The multifunction peripheral 1 further includes the reception section 107 that accepts a selection of the print job from among print jobs displayed on the operation display section 14. The print execution section 105 executes the printing based on the print job accepted by the reception section 107.

According to this, since the printing is executed based on the print job selected by the user P, it is possible to securely perform the charging printing using the mobile wallet 311, and it is possible to execute the printing for the print job desired by the user P.

The multifunction peripheral 1 includes the display controller 106 that causes the operation display section 14 to display a payment amount for the printing based on the print job. When the authentication is successfully performed by the authentication section 104, the display controller 106 causes the operation display section 14 to display the payment amount before the print execution section 105 executes the printing.

According to this, the user P can grasp the amount of money to be charged for the printing before executing the printing.

The second communication controller 102 transmits the payment request, when the second communication controller 102 is connected to the second terminal device 3 again by NFC communication after receiving the user ID 312.

According to this, the charging printing is not executed unless the second terminal device 3 is connected again by the NFC communication. For this reason, occurrence of a situation in which charging printing is being performed without awareness may be suppressed.

When the settlement completion notification is received, the second communication controller 102 transmits at least one of a payment completion notification and paid amount information to the mobile wallet 311. The paid amount information indicates the amount of money paid for the printing based on the print job.

According to this, the user P can recognize that the printing is charged.

The multifunction peripheral 1 includes a sheet count processor 108 that performs a process of adding the number of sheets printable without charging to the user ID 312 when an error occurs in the printing based on the print job.

According to this, in a case where an error occurs in printing, the number of sheets printable without charging is assigned to the user P, and thus it is possible to appropriately cope with a case where printing is not appropriately performed even though charging is performed.

The sheet count processor 108 performs a process of adding, as the number of sheets printable without charging, the total number of sheets to be subjected to printing in the print job to the user ID 312.

According to this, even in a case where an error occurs in the middle of the execution of the print job, all of the number of sheets to be subjected to printing by the print job is assigned to the user P as the number of sheets printable without charging. Since the user P generally desires printed matter in a print job unit, it is possible to more appropriately cope with the case where the printing is not appropriately performed although the user P is charged.

The multifunction peripheral 1 includes the refund processor 109 that performs a refund process to the mobile wallet 311 when an error occurs in the printing based on the print job.

According to this, in a case where an error occurs in printing, the number of sheets printable without charging is assigned to the user P, and thus it is possible to appropriately cope with a case where printing is not appropriately performed even though charging is performed.

The refund process is a process of refunding the amount of money paid for the printing based on the print job.

According to this, even when an error occurs during the execution of the print job, the amount of money paid for the print job is refunded. Since the user P generally desires printed matter in a print job unit, it is possible to more appropriately cope with the case where the printing is not appropriately performed although the user P is charged.

In a control method of the multifunction peripheral 1, a print request including a print job is received from the first terminal device 2. Furthermore, in the control method of the multifunction peripheral 1, the user ID 312 is received from the second terminal device 3 in which the mobile wallet 311 is installed. In the control method of the multifunction peripheral 1, authentication is performed based on the received user ID 312. Furthermore, in the control method of the multifunction peripheral 1, when the authentication is successfully performed, a payment request for printing based on the print job is transmitted to the mobile wallet 311. In the control method of the multifunction peripheral 1, a payment execution request corresponding to the payment request is received from the mobile wallet 311. In the control method of the multifunction peripheral 1, when the payment execution request is received, a settlement request for the printing based on the print job is transmitted to the settlement server 4. Moreover, in the control method of the multifunction peripheral 1, a settlement completion notification is received from the settlement server 4. In the control method of the multifunction peripheral 1, when the settlement completion notification is received, printing based on the print job is executed.

According to this configuration, the same effect as the effect of the multifunction peripheral 1 described above is achieved.

The control program 111 causes the multifunction peripheral processor 100 to function as the first communication controller 101, the second communication controller 102, the third communication controller 103, the authentication section 104, and the print execution section 105.

According to this configuration, the same effect as the effect of the multifunction peripheral 1 described above is achieved.

### 2. Second Embodiment

Next, a second embodiment will be described.

When the second embodiment is compared with the first embodiment, configurations of individual sections of a printing system 1000 of the second embodiment are different from those of the first embodiment in that a first terminal memory 210 stores a user ID 312.

When the second embodiment is compared with the first embodiment, an operation of the printing system 1000 of the second embodiment is different.

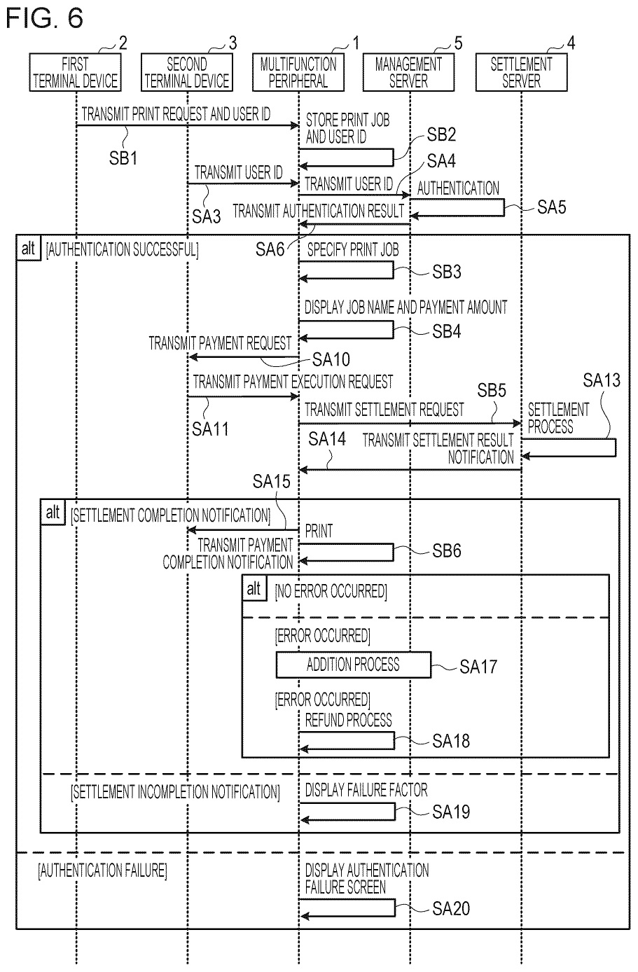

FIG. 6 is a sequence diagram illustrating operations of the individual sections of the printing system 1000 according to the second embodiment.

In the sequence diagram illustrated in FIG. 6, the same steps as those in the sequence diagram illustrated in FIG. 5 are denoted by the same step numbers, and the detailed description thereof will be appropriately omitted.

When an instruction for a print request is received from a user P via a terminal input section 23, a driver execution section 201 transmits a print request and a user ID 312 to the multifunction peripheral 1 (step SB1).

Then, upon receiving the print request and the user ID 312 from a first terminal device 2, a first communication controller 101 stores a print job included in the print request and the user ID 312 in association with each other in a multifunction peripheral memory 110 (step SB2).

When the authentication of an authentication section 104 has been successfully performed, a display controller 106 specifies a print job associated with the user ID 312 received by the second communication controller 102 in the multifunction peripheral memory 110 (step SB3).

Subsequently, the display controller 106 causes an operation display section 14 to display a job name of the specified print job and a payment amount (step SB4). In this embodiment, the payment amount is an amount to be paid by the user P for printing based on the print job specified in step SB3.

When the second communication controller 102 receives a payment execution request, a third communication controller 103 transmits a settlement request to a settlement server 4 (step SB5). The settlement request according to this embodiment is information for requesting settlement for the printing based on the print job specified in step SB3. The settlement request according to this embodiment includes payment amount information indicating a payment amount for the print job specified in step SB3.

A print execution section 105 executes printing based on the print job (step SB6). In this embodiment, the print execution section 105 executes printing based on the print job specified in step SB3.

As described above, in the second embodiment, a print job to be printed is specified without displaying a selection screen. Accordingly, an operation of selecting a print job in the selection screen is not required to be performed, and time and effort of the user P required for printing can be reduced.

### 3. Third Embodiment

Next, a third embodiment will be described.

When the third embodiment is compared with the second embodiment, configurations of individual sections of a printing system 1000 of the third embodiment are the same as those of the second embodiment.

When the third embodiment is compared with the second embodiment, the printing system 1000 of the third embodiment operates differently from the printing system 1000 of the second embodiment.

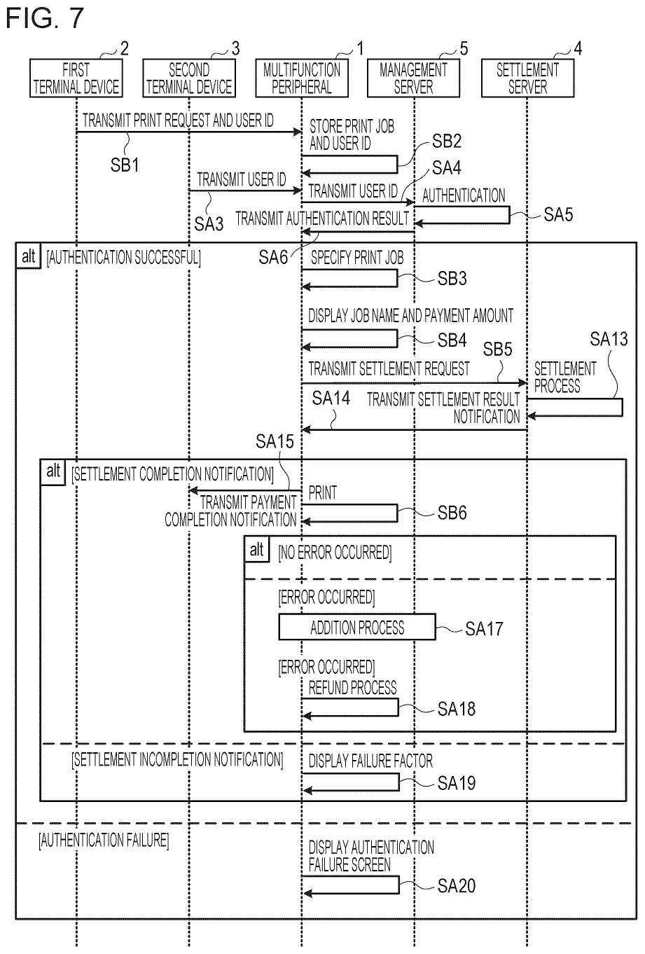

FIG. 7 is a sequence diagram illustrating operations of the individual sections of the printing system 1000 according to the third embodiment.

In the sequence diagram illustrated in FIG. 7, the same steps as those in the sequence diagram illustrated in FIG. 6 are denoted by the same step numbers, and the detailed description thereof will be appropriately omitted.

As is clear from a comparison between FIGS. 7 and 6, steps SA10 and SA11 are not performed in the third embodiment. That is, in the third embodiment, a second terminal device 3 and a multifunction peripheral 1 perform settlement without a user P holding the second terminal device 3 over the multifunction peripheral 1 again and without performing short-range wireless communication.

As described above, in the third embodiment, charging printing and authentication printing are executed without the user P holding the second terminal device 3 over an NFC reader 12 a plurality of times and without the second terminal device 3 and the multifunction peripheral 1 performing short-range wireless communication. Therefore, time and effort of the user P for printing can be reduced.

### 4. Fourth Embodiment

Next, a fourth embodiment will be described.

When the fourth embodiment is compared with the first to third embodiments, configurations of individual sections of a printing system 1000 according to the fourth embodiment are different in the following points.

The printing system 1000 according to the fourth embodiment does not include a management server 5.

Furthermore, the multifunction peripheral 1 of the fourth embodiment stores an authentication database and a sheet count management DB 512 in a multifunction peripheral memory 110.

An authentication section 104 of the fourth embodiment refers to the authentication database storing a user ID 312 to determine whether the user ID 312 is stored in the authentication database. The authentication section 104 determines that the authentication is successfully performed when determining that the user ID 312 is stored, and determines that the authentication fails when determining that the acquired user ID 312 is not stored.

In addition, a sheet count processor 108 of the fourth embodiment specifies a record R2 having the user ID 312 transmitted by a second terminal device 3 in a sheet count management DB 512, and adds the acquired number of sheets for printing to the number of sheets indicated by sheet count information of the specified record R2 as the number of sheets printable without charging.

Next, operations of the individual sections of the printing system 1000 according to the fourth embodiment will be described.

When the fourth embodiment is compared with the first to third embodiments, in the printing system 1000 of the fourth embodiment, authentication based on the user ID 312 is performed only by a multifunction peripheral 1, and an addition process is performed only by the multifunction peripheral 1.

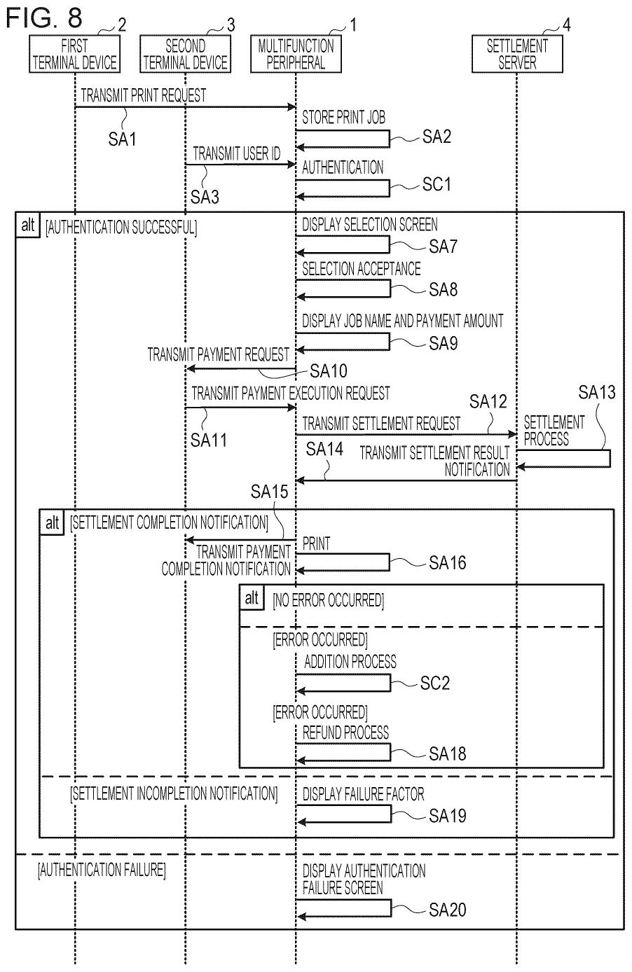

Hereinafter, operations of the fourth embodiment which are different from those of the first to third embodiments will be described with reference to FIG. 8.

FIG. 8 is a sequence diagram illustrating operations of the individual sections of the printing system 1000 according to the fourth embodiment.

In the sequence diagram illustrated in FIG. 8, the same steps as those in the sequence diagram illustrated in FIG. 6 are denoted by the same step numbers, and the detailed description thereof will be appropriately omitted.

When the second communication controller 102 receives the user ID 312, the authentication section 104 authenticates a user P based on the received user ID 312 (step SC1). When the authentication has been successfully performed by the authentication section 104, the display controller 106 causes an operation display section 14 to display a selection screen (step SA7).

When an error occurs in printing performed by the print execution section 105, the sheet count processor 108 executes an addition process (step SC2). In step SC2, the sheet count processor 108 specifies a record R2 having the user ID 312 transmitted by the second terminal device 3 in the sheet count management DB 512. Thereafter, in step SC2, the sheet count processor 108 adds the acquired number of sheets for printing to the number of sheets indicated by the sheet count information of the specified record R2 as the number of sheets printable without charging.

### 5. Other Embodiments

The above-described embodiments are preferred embodiments of the present disclosure. However, the present disclosure is not limited to the above-described embodiments, and various modifications may be made without departing from the scope of the present disclosure.

In the above-described embodiments, the case where the first terminal device 2 and the second terminal device 3 are different devices has been exemplified, but the first terminal device 2 and the second terminal device 3 may be the same device.

In the above-described embodiments, the multifunction peripheral 1 is exemplified as the “image forming apparatus”. As another embodiment, the “image forming apparatus” may be a printer that does not have a function other than a print function, such as a scan function. Furthermore, as still another embodiment, the “image forming apparatus” may be an apparatus that executes image formation, and may be, for example, a scanner that forms an image by a scanning function.

Moreover, as a further embodiment, the functions of the settlement server 4 and the management server 5 may be executed by a single server device.

The functions of the multifunction peripheral controller 10, the first terminal controller 20, the second terminal controller 30, the first server controller 40, and the second server controller 50 may be implemented by a plurality of processors or semiconductor chips.

Furthermore, the configurations of the individual sections of the printing system 1000 illustrated in FIGS. 2, 3, and 4 indicate functional configurations, and a specific implementation form is not particularly limited. That is, hardware components individually corresponding to the individual functional sections are not necessarily mounted, and a configuration in which one processor executes a program to realize a plurality of functions may be employed. Moreover, in the above-described embodiments, some of the functions implemented by software may be implemented by hardware, and some of the functions implemented by hardware may be implemented by software. In addition, specific detailed configurations of the other sections of the multifunction peripheral 1, the first terminal device 2, the second terminal device 3, the settlement server 4, and the management server 5 may also be arbitrarily changed without departing from the scope of the present disclosure.

Also, the processing units in the sequence diagrams illustrated in FIGS. 5, 6, 7, and 8 are divided according to the main processing content in order to facilitate understanding of the processes of the individual sections of the printing system 1000, and the present disclosure is not limited by the method for dividing processing units or the names. The process may be divided into a large number of steps in accordance with the processing content. Furthermore, one step unit may be divided so as to include many processes. In addition, the order of the steps may be appropriately changed without departing from the scope of the present disclosure.

What is claimed is:

1. An image forming apparatus, comprising:
a first communication controller that communicates with a first terminal device;
a second communication controller that communicates with a second terminal device in which an application program having a wallet function is installed;
a third communication controller that communicates with a settlement server;
an authentication section that authenticates a user; and
an image formation execution section that executes image formation, wherein
the first communication controller receives an image forming request including an image forming job from the first terminal device,
the second communication controller receives identification information of the user from the second terminal device,
the authentication section performs authentication based on the identification information received,
the second communication controller transmits a payment request for the image formation based on the image forming job to the application program when the authentication is successfully performed by the authentication section,
the second communication controller receives a payment execution request corresponding to the payment request from the application program,
the third communication controller transmits a settlement request for the image formation based on the image forming job to the settlement server when the payment execution request is received,
the third communication controller receives a settlement completion notification from the settlement server, and
the image formation execution section executes the image formation based on the image forming job when the settlement completion notification is received.

2. The image forming apparatus according to claim 1, further comprising:
a display controller that causes a display section to display the image forming job when the authentication is successfully performed by the authentication section; and
a reception section that accepts a selection of the image forming job from among image forming jobs displayed on the display section, wherein
the image formation execution section executes the image formation based on the image forming job accepted by the reception section.

3. The image forming apparatus according to claim 1, further comprising
a display controller that causes a display section to display a payment amount for the image formation based on the image forming job, wherein
when the authentication is successfully performed by the authentication section, the display controller causes the display section to display the payment amount before the image formation execution section executes the image formation.

4. The image forming apparatus according to claim 1, wherein
the second communication controller transmits the payment request, when the second communication controller is connected to the second terminal device again by short-range wireless communication after receiving the identification information.

5. The image forming apparatus according to claim 1, wherein
when the settlement completion notification is received, the second communication controller transmits at least one of a payment completion notification and paid amount information to the application program, and
the paid amount information indicates an amount of money paid for the image formation based on the image forming job.

6. The image forming apparatus according to claim 1, further comprising
a sheet count processor that performs a process of adding a number of sheets available for image formation without charging to the identification information when an error occurs in the image formation based on the image forming job.

7. The image forming apparatus according to claim 6, wherein
the sheet count processor performs a process of adding, as the number of sheets available for image formation without charging, a total number of sheets on which images are to be formed in the image forming job to the identification information.

8. The image forming apparatus according to claim 1, further comprising
a refund processor that performs a refund process to the application program when an error occurs in the image formation based on the image forming job.

9. The image forming apparatus according to claim 8, wherein
the refund process is a process of refunding an amount of money paid for the image formation based on the image forming job.

10. A method for controlling an image forming apparatus, comprising:
receiving an image forming request including an image forming job from a first terminal device;
receiving identification information of a user from a second terminal device in which an application program having a wallet function is installed;
performing authentication based on the identification information received;
transmitting, when the authentication is successfully performed, a payment request for image formation based on the image forming job to the application program;
receiving a payment execution request corresponding to the payment request from the application program;
transmitting a settlement request for the image formation based on the image forming job to a settlement server when the payment execution request is received;
receiving a settlement completion notification from the settlement server; and
executing the image formation based on the image forming job when the settlement completion notification is received.

11. A non-transitory computer-readable storage medium storing a program that causes a processor to function as:
a first communication controller that communicates with a first terminal device;
a second communication controller that communicates with a second terminal device in which an application program having a wallet function is installed;
a third communication controller that communicates with a settlement server;
an authentication section that authenticates a user; and
an image formation execution section that executes image formation, wherein
the first communication controller receives an image forming request including an image forming job from the first terminal device,
the second communication controller receives identification information of the user from the second terminal device,
the authentication section performs authentication based on the identification information received,
the second communication controller transmits a payment request for the image formation based on the image forming job to the application program when the authentication is successfully performed by the authentication section,
the second communication controller receives a payment execution request corresponding to the payment request from the application program,
the third communication controller transmits a settlement request for the image formation based on the image forming job to the settlement server when the payment execution request is received,
the third communication controller receives a settlement completion notification from the settlement server, and
the image formation execution section executes the image formation based on the image forming job when the settlement completion notification is received.
